(19) United States
(12) Patent Application Publication
(10) Pub. No.: US 2012/0061893 A1
(43) Pub. Date: Mar. 15, 2012

(54) KINETIC ENERGY MANAGEMENT SYSTEM

(76) Inventors: David J. Hochberg, Oak Park, MI (US); Gregory E. Peterson, Sylvan Lake, MI (US)

(21) Appl. No.: 13/208,016

(22) Filed: Aug. 11, 2011

Related U.S. Application Data
(60) Provisional application No. 61/372,766, filed on Aug. 11, 2010.

(51) Int. Cl. F16F 15/03; F16F 6/00

(52) U.S. Cl. 267/195; 188/267

(57) ABSTRACT

A vehicle kinetic energy management system including a first main body having a passive magnetic component movable therewith and a second main body movably attached to the first main body for reciprocal movement there between. The second main body including an active magnetic component movable therewith and magnetically communicating with the passive magnetic component. One of the first and second main bodies being adapted for engagement with a vehicular component that experiences irregularities of a surface on which the vehicle travels, and the other main body engaging a load-bearing portion of the vehicle for which isolation from the vibrations is desired. Interaction of the active and passive magnetic components in response to the relative movement of the first and second main bodies translates between reciprocating kinetic energy associated with the vehicle motion over the surface irregularities and electrical energy associated with the active magnetic component.

### CROSS-REFERENCE TO RELATED APPLICATIONS

This application is related to and claims priority to U.S. Provisional Patent Application Ser. Number 61/372,766, filed on Aug. 11, 2010, bearing the title “Kinetic Energy Management System”. This application is also related to U.S. provisional application Ser. No. 61/171,641, filed on Apr. 22, 2009, bearing the title “Kinetic Energy Conversion Device”, U.S. provisional application Ser. No. 61/352,120, filed on Jun. 7, 2010, bearing the title “Rotational Kinetic Energy Conversion System”, and Patent Cooperation Treaty Patent Application Ser. No. PCT/US10/32,037, filed Apr. 22, 2010, bearing the title “Energy Conversion Device”. All disclosures in these prior applications are incorporated by reference herein.

### TECHNICAL FIELD

This disclosure is related generally to energy management systems capable of managing kinetic energy in the form of vibrating mechanical input. In particular, this disclosure is directed to energy management systems for absorbing transverse shock or vibration experienced by a moving vehicle.

### BRIEF SUMMARY

A kinetic energy management system is disclosed for managing vibration experienced by a moving vehicle, where the vibration occurs in a direction generally transverse to the direction of movement of the vehicle.

One exemplary kinetic energy management system includes an electromechanical shock absorber device comprising a first main body movably attached to a second main body for reciprocal movement therebetween, the first main body having a winding or coil movable therewith and the second main body having a magnet movable therewith. The magnet may be movable relative to the winding by the reciprocal relative movement of the first and second main bodies such as to generate a current in the winding. One of the first or second main bodies is adapted for engagement with a vehicular component that experiences the irregularities of a surface on which the vehicle travels and the other of the main bodies is adapted for engagement with a load bearing portion of the vehicle for which isolation from the vibrations due to irregularities of the surface is desired. The interaction of the magnet and the winding may be used to translate between reciprocating kinetic energy associated with the motion of the vehicle over the surface irregularities and electrical energy associated with current through the winding. The vehicle may be a car or truck and the surface may be a road. Alternatively, the vehicle may be a boat and the surface may be the surface of a body of water.

Another exemplary kinetic energy management system includes an electromagnetic shock absorber having at least two nested magnetic components, such as toroidal magnetic components, one active component creating a magnetic field and one passive component from which the energy of the field is converted to mechanical energy, or visa versa, through relative movement between the active and passive component. The passive component may be a magnetic piston and the active component may be a coiled electrical winding. For conversion of kinetic energy into electrical energy, external forces, originating from surface irregularities as a vehicle travels in a forward direction, cause relative movement between the magnetic components resulting in current flowing through the active component.

In another electromechanical shock absorber, a winding or coil defines a longitudinal axis. Two fixed magnets, one disposed at each end of the longitudinal axis, act on a magnetic piston movably disposed relative to the winding and displaceable along the longitudinal axis. The relative motion between the piston and the winding may be horizontal or vertical or at any angle therebetween.

In still another exemplary system, the electromechanical shock absorber has an elongated channel defined by a radial magnetic source, a winding disposed coaxial with the radial magnetic source, two oppositely disposed axial magnets in fixed locations at opposing ends of the elongated channel and a piston disposed therebetween. The radial axial magnets may be rare earth magnets such as neodymium magnets.

The energy management system may be used to passively absorb a portion of the transverse vibration by surface irregularities as well as to provide electrical energy for later use by passively converting the kinetic energy to electricity. Alternatively, the energy management system may be used to actively manage the amplitude or the frequency of the transverse vibrations experienced by the load-bearing portion of the vehicle by selective application of a current to the windings. The energy management system may therefore include an electronic control system to control the application of current to the winding as well as to regulate the use of current generated in the winding by the movement of the magnet.

The first and second main bodies of the electromagnetic shock absorber may create an enclosure or housing for the magnet, the winding, electronic controls, shock-absorbing components, and a spring. The main body may be constructed to have a similar shape and mounting function as a conventional mechanical shock absorber or may have alternate shapes and features for special applications.

The magnet may be a disc shaped compound complex radial magnetic piston manufactured or selected to effectively present axial poles of opposing polarity on its respective faces as well as to effectively present a radial pole of a single polarity.

In still another exemplary device, the piston may be a complex magnet having an axial magnetic component responsive to the oppositely disposed axial magnets, and a radial magnetic component responsive to the radial magnetic source to generally maintain the piston in a floating position within an elongated channel defined by the winding or coil. The opposing magnetic fields of the oppositely disposed axial magnets confine the floating piston within the channel and increase the number and speed of the oscillations. A cylinder may be provided defining the channel and may be wrapped tightly with a toroidal copper winding defining the winding. As the piston passes through the winding, its movement creates a moving magnetic field that is converted into electrical current flowing through the winding.

Additional magnets may be configured around the cylinder allowing the piston to float freely, reducing friction between the piston and the walls of the cylinder.

The energy management system may be used in parallel or in series with a mechanical energy managing system such as a mechanical shock absorber or a mechanical spring. Alternatively, a mechanical energy managing system may be integrated into a shock-absorbing device of the type disclosed herein.

In one exemplary energy management system disclosed, the vehicle using an electromagnetic shock absorber is a car or truck and the surface is a road. The electromagnetic shock absorber is installed in parallel with a conventional mechanical shock absorber or spring. Alternatively, the electromechanical shock absorber incorporates mechanical shock absorbing components and is substituted for a conventional mechanical shock absorber. Alternatively, the electromechanical shock absorber incorporates a spring and is substituted for a conventional mechanical spring.

In another exemplary embodiment, the vehicle is a boat and the surface is the surface of a body of water. An electromechanical shock absorber may be installed between the hull of the boat and a pontoon floating on the surface of the water adjacent the hull. A plurality of electromechanical shock absorbers may be provided adjacent each side of the boat coupled to one or more pontoons on each side of the boat. The action of waves will displace the magnet relative to the windings of the electromechanical shock absorbers to induce current in the windings to generate electrical power or to provide a damping effect on the motion of the boat in response to the waves. The windings of the electromechanical shock absorbers may also be selectively powered to raise the pontoons above the water surface when desired.

### BRIEF DESCRIPTION OF THE DRAWINGS

Some configurations of the energy management system will now be described, by way of example only and without disclaimer of other configurations, with reference to the accompanying drawings, in which:

FIG. 1 is a schematic view of a prior art automotive shock absorbing system including conventional mechanical shock absorbers;

FIG. 2 is a schematic view of a conventional mechanical shock absorber illustrating the operation thereof, with its internal components in an extended operational configuration;

FIG. 3 is a schematic view of the shock absorber of FIG. 3 with its internal components in an compressed operational configuration;

FIG. 4 is a schematic perspective view of a conventional shock absorber mounted in parallel with an exemplary electromagnetic shock absorber;

FIG. 5 is a schematic perspective view of a conventional shock absorber mounted in parallel with an alternative exemplary electromagnetic shock absorber;

FIG. 6 is a schematic perspective view of another alternative exemplary electromechanical shock absorber which may be substituted for a conventional mechanical shock absorber;

FIG. 7 is a sectional view of the electromagnetic shock absorber of FIG. 4 taken along line 7-7 thereof;

FIG. 8 is a partial sectional view of the electromagnetic shock absorber of FIGS. 4 and 7 taken along line 8-8 of FIG. 7;

FIG. 9 is an exploded schematic view of certain internal components of the electromagnetic shock absorber of FIGS. 57 and 9;

FIG. 10 is an exploded schematic view similar to FIG. 9 but illustrating an alternative exemplary electromagnetic shock absorber;

FIG. 11 is a sectional view similar to FIG. 7, but illustrating another alternative exemplary electromagnetic shock absorber with control components incorporated into its housing;

FIG. 12 is a sectional view similar to FIG. 7, but illustrating still another alternative exemplary electromagnetic shock absorber with damping components incorporated into its housing;

FIG. 13 is a sectional view similar to FIG. 7, but illustrating yet another alternative exemplary electromagnetic shock absorber with damping components and a spring incorporated into its housing;

FIG. 14 is a perspective view of an exemplary linear kinetic energy management system including an electromechanical shock absorber for use in association with a boat;

FIG. 15 is a perspective view of an alternate exemplary kinetic energy management system including a plurality of electromechanical shock absorbers for use in association with a boat;

FIG. 16 is a side elevational view of the kinetic energy management system of FIG. 15;

FIG. 17 is a top plan view of the kinetic energy management system of FIGS. 15 and 16;

FIG. 18 is a front elevational view of the kinetic energy management system of FIGS. 15-17, illustrating the kinetic energy management system mounted to the side of a boat; and

FIG. 19 is a sectional view through yet another kinetic energy management system having an electromagnetic shock absorber incorporated into a float.

### DETAILED DESCRIPTION OF THE DISCLOSURE

Referring now to the drawings, exemplary energy management systems are shown in detail. Although the drawings represent alternative configurations of energy management systems, the drawings are not necessarily to scale and certain features may be exaggerated to provide a better illustration and explanation of a configuration. The configurations set forth herein are not intended to be exhaustive or to otherwise limit the device to the precise forms disclosed in the following detailed description.

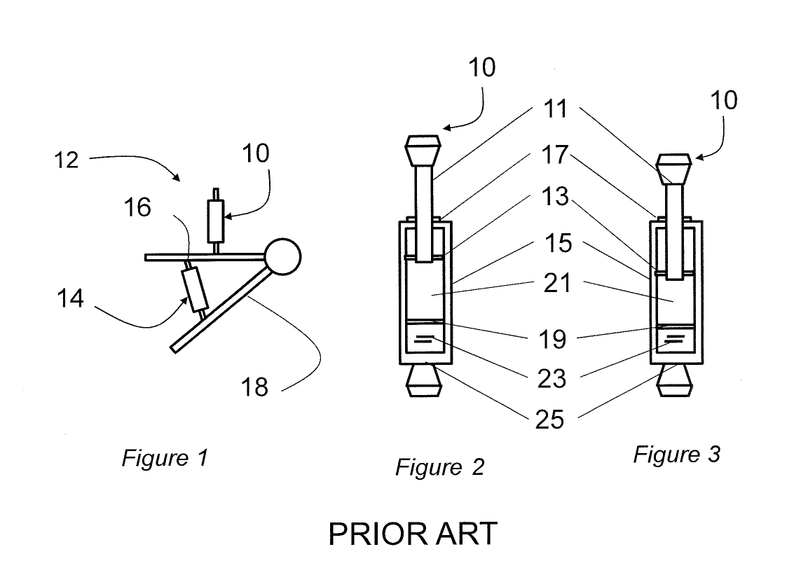

Referring now to the drawings, FIG. 1 schematically illustrates an example of a prior art automotive energy management system 12 using conventional mechanical shock absorbers 10 to isolate the load bearing portion of a vehicle, such as a passenger compartment, from the vibrations of the wheel and axle system experienced as the vehicle moves in a forward direction over an uneven road surface. As shown in FIG. 1, prior art energy management systems 12 may include a spring 14, such as a coil spring or a leaf spring, to further manage the vibration between suspension components 16 and 18.

FIGS. 2 and 3 schematically illustrate a conventional mechanical shock absorber 10 with its internal components in an extended and compressed configuration, respectively. As illustrated, a conventional mechanical shock absorber 10 typically has a rod 11 having a piston 13 on its extreme end reciprocally mounted in a cylinder 15 such that piston 13 sealingly engages an inner wall of cylinder 15. A seal 17 is also provided between the free end of rod 11 and an end 25 of cylinder 15 receiving rod 11. A floating piston 19 divides cylinder 15 into an oil reservoir 21, in which piston 13 is free to oscillate along the longitudinal axis of cylinder 15, and an air chamber 23 disposed remote from piston 13. As seen by comparing FIG. 2 and FIG. 3, the oil in oil reservoir 21 resists the motion of piston 15 in response to vibration input to shock absorber 10, thereby absorbing some of the kinetic energy in the vibration. Floating piston 19 is free to move in response to the compression of oil in oil reservoir 21 as piston 13 is moved by rod 11.

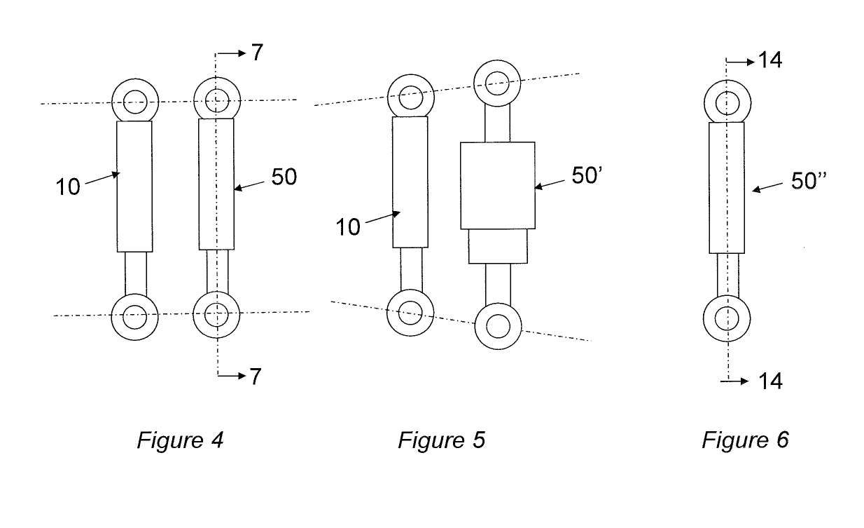

Referring to FIG. 4, an electromagnetic shock absorber 50 may be placed in mechanical parallel with conventional mechanical shock absorber 10 to convert a portion of the kinetic energy of vibrations experienced by the shock absorbers 10 and 50 into electrical energy. As shown in FIG. 4, electromagnetic shock absorber 50 may be configured to be of the same length and diameter as conventional mechanical shock absorber 10 and may be extended between the same components as conventional mechanical shock absorber 10 in adjacent mounting locations. Alternatively, as shown in FIG. 5, electromagnetic shock absorber 50′ may be configured differently than conventional mechanical shock absorber 10 and may be extended between different components of a suspension system or at mounting points experiencing a different amount of displacement than conventional mechanical shock absorber 10. For some applications in particular, it may be desirable to intentionally use a leveraging system so that electromagnetic shock absorber 50′ and conventional mechanical shock absorber 10 experience different force levels in response to vibration to optimize their load absorbing or electrical energy generating characteristics.

Alternatively, as shown in FIG. 6 an electromagnetic shock absorber 50″ may be manufactured to the same dimensions as a conventional mechanical shock absorber and have shock absorbing components incorporated therein, as described in detail later herein. Electromechanical shock absorber 50″ may therefore be substituted for a conventional mechanical shock absorber in a suspension system since it offers the functionality of both types of shock absorbers.

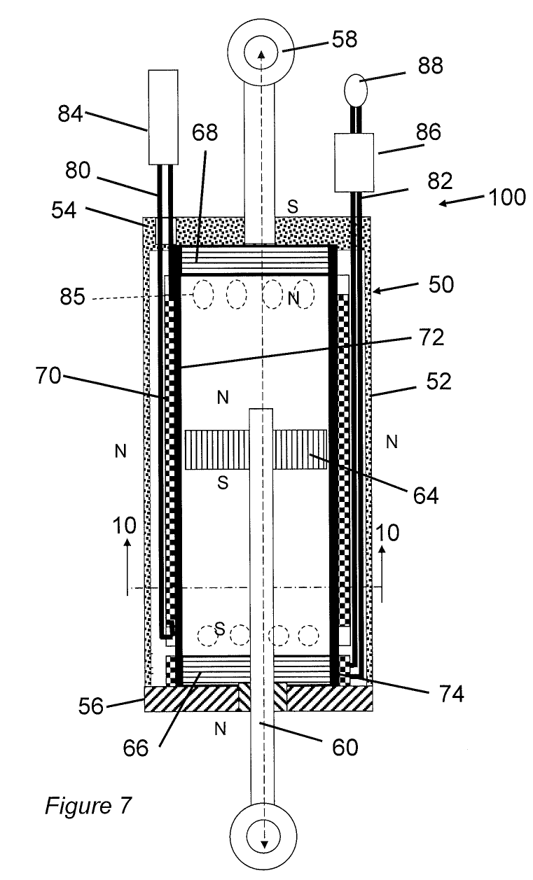

Referring now generally to FIGS. 7-13 various exemplary electromagnetic shock absorbers 50, 50′, 50″ and 50a are illustrated and the general arrangement of the mechanical, magnetic and electromagnetic components of energy management system 100 will be described.

Referring generally to FIGS. 7-9, schematically illustrating a generalized electromechanical shock absorber 50, and more particularly to FIG. 7, illustrating a section through shock absorber 50, the arrangement of the magnetic and electromagnetic components will be described. In particular, electromechanical shock absorber 50 includes a cylinder 52 having an upper end wall 54 and a lower end wall 56. A first rod 58 is fixed to the upper end 54 connectable to a first suitable mounting point on a suspension system. A second rod 60, connectable to second suitable mounting point of a suspension system, is inserted through an aperture in the lower end wall 56 and is reciprocal relative to cylinder 52.

A magnetic piston 64 is mounted to rod 60 within cylinder 52 and is constrained to oscillate within cylinder 52 in response to relative movement between the first and second mounting points of the suspension system. Magnetic piston 64 may be press fitted to rod 60 or secured thereto by other means, such as clips. Magnetic piston 64 may be a complex magnet having an axial magnetic component and a radial magnetic component, as illustrated and described in related U.S. patent application Ser. No. 61/171,641 and PCT patent application Ser. No. PCT/US10/32,037 described above and incorporated by reference herein.

An optional pair of axial magnets 66 and 68 may be disposed within cylinder 52 adjacent walls 54 and 56. Magnets 66 and 68 and magnetic piston 64 are oriented to present faces to each other of opposite polarity. Magnets 68 and 66 may be used to assist in the orientation of magnet piston 64 and to manage the oscillatory motion of magnet piston 64.

A winding, such as a toroidal winding 70, is provided within cylinder 52, which may be protected from magnetic piston 70 by a cylindrical wall 72. Magnetic piston 64 extends nearly to wall 72. For some applications, it may be desirable for magnetic piston 64 to form a sliding seal with wall 72. It will be appreciated that oscillatory motion of magnetic piston 64 within cylinder 52 will cause a current to flow in toroidal winding 70, thus permitting the winding to convert the kinetic energy of vibrations in the suspension system to electrical energy which may be used by the vehicle. Conversely, driving a current through toroidal winding 70 will impart a force on a magnetic piston 64, causing relative motion between rods 58 and 60, which may in turn deliver a force to the components of the suspension system to manage the oscillatory motion there between.

Electromechanical shock absorber 50 optionally includes another toroidal winding 74 disposed adjacent axial magnet 66. Toroidal winding 74 may also be selectively energized to temporarily exert a force on magnetic piston 64 to initiate or assist the oscillation of magnetic piston 64. Wires 80 and 82 connected respectively to toroidal winding 70 and 74 extend from cylinder 52 to an external load 84 for the use of the current generated in winding 70 and connect toroidal windings 72 and 74 to an external source of power 86 and controller 88 for selectively powering the windings.

Cylinder 52 may be provided with apertures 85 for admission of air to cool the internal components and to regulate the buildup of air pressure on opposing sides of magnetic piston 64.

Electromechanical shock absorber 50 may be configured to provide either alternating current or direct current output. Electrical load 84 may be one or more electrical devices capable of consuming the power, one or more storage devices used to store power for later use, or a power distribution system. Exemplary storage devices for electrical load 84 may include the vehicle main battery or a local battery for use by controller 88 and may therefore be the same component as power source 86.

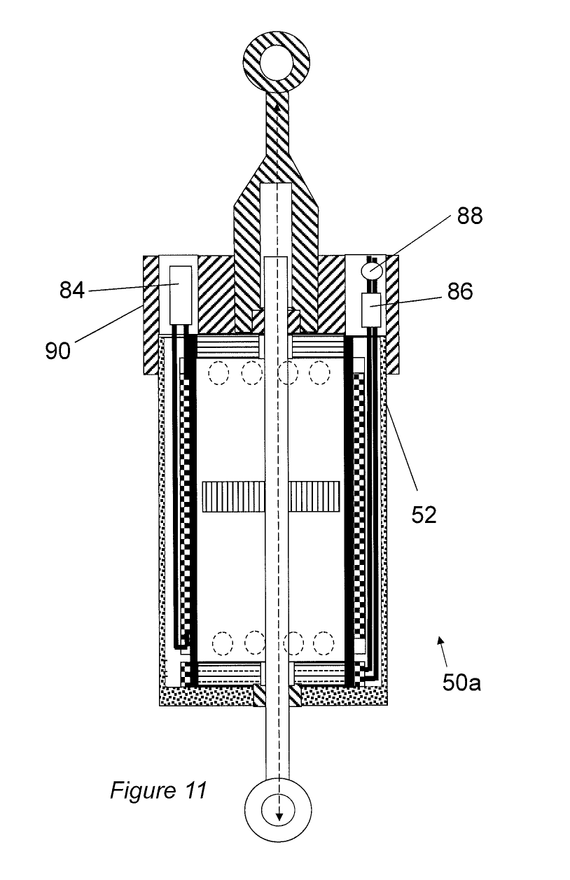

While power source 86, controller 88, and electrical load 84 are schematically illustrated as independent of electromechanical shock absorber 50, either or both may be integrated with an electromechanical shock absorber 50a of FIGS. 6 and 11, as best shown in FIG. 11 and described below. In particular, one or both may alternatively be affixed to a cover 90 mounted over one end of cylinder 52.

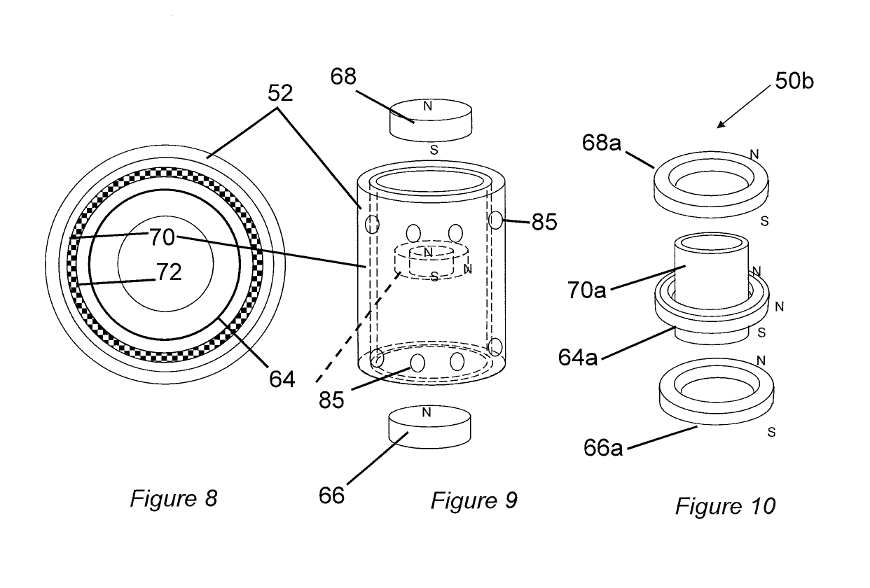

FIG. 10 schematically illustrates an alternative electromechanical shock absorber 50b, in which the arrangement of the magnetic and electromagnetic components is similar to those described above, except that piston 64a and axial magnets 66a and 68a are ring-shaped. In this arrangement, piston 64a is disposed outside of the toroidal winding 70a. Magnetic piston 64a interacts with axial magnets 68a and 66a and toroidal winding 70a according to the same principles as the similarly numbered components of the electromechanical shock absorber 50 of FIGS. 7 and 8 described above.

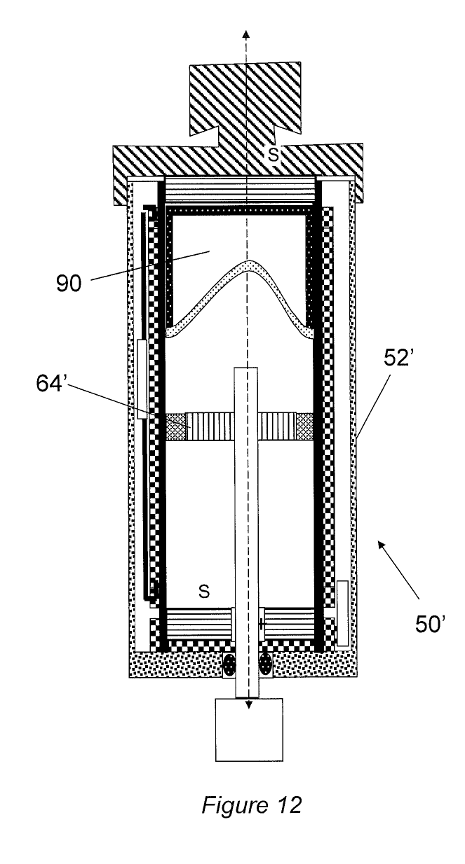

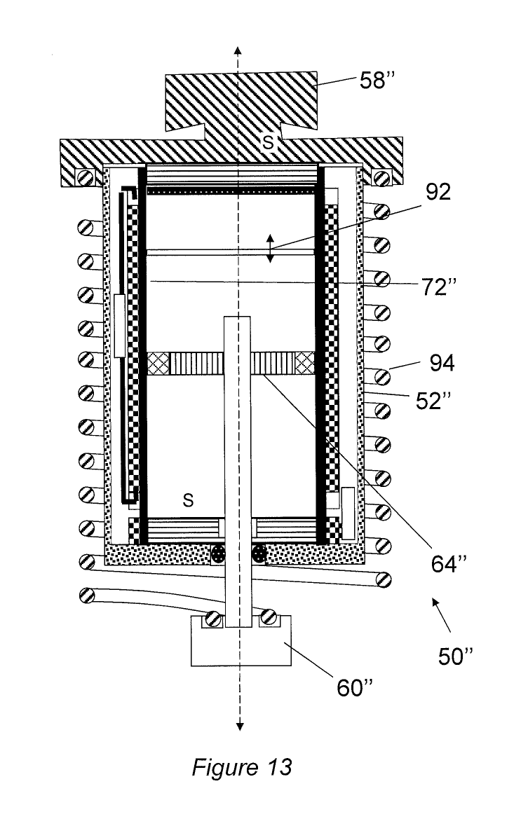

Still other configurations are possible. For example, FIG. 12 schematically illustrates an alternative electromechanical shock absorber 50′, in which a mechanical vibration absorbing system has been included. In particular, a fluid compartment 90 surrounded by wall 72′ resiliently flexes and absorbs some vibration in response to the pressure caused by the movement of piston 64′. FIG. 13 schematically illustrates another alternative electromechanical shock absorber 50″, in which a mechanical vibration absorbing system and a spring 94 has been included. In particular, a floating piston 92 engages wall 72″ and is displaceable in response to the pressure caused by the movement of piston 64″ to absorb some vibration between rods 58″ and 60″. A spring 94 wound around the outside of cylinder 52″ and connected to rods 58″ and 60″ is provided in mechanical parallel arrangement with shock absorber 50″.

It should be noted that a plurality of toroidal windings may be provided. One or more passive toroidal windings may be provided to create an output current as a function of the motion of piston 64, 64′ or 64a. One or more active toroidal windings may also be provided to create a magnetic field opposing the magnetic field of piston 64, 64′ or 64″ for selectively driving the piston when active oscillation management is desired. The passive toroidal winding may be significantly larger than the active toroidal winding. As described above, the energy created by piston 64, 64′ or 64a interacting with a passive toroidal winding may be transferred to and stored in an electrical storage device 84, such as a battery or capacitor. An active toroidal winding may use the electrical energy previously created by the moving piston magnets interacting with the passive toroidal winding and subsequently stored in electrical storage device 84. The toroidal windings may be wound about and supported by wall 72 or by a tube formed of a suitable non-conductive material such as plastic.

It will be appreciated that electromechanical shock absorbers 50, 50′ and 50″ may be used in other applications, such as non-vehicular applications, as a generator, a motor, a pump, a compressor, an engine, or an electrical power transformer. When used as a transformer, electrical power may be input to passive toroidal windings and electrical power may be output from active toroidal windings. When used as a generator, mechanical power may be input by reciprocally moving the rods relative to each other and electrical power may be output from a passive toroidal winding. The output of the energy conversion device can be configured to be direct or alternating current. The mechanical motion may be provided, for example, by any source that is capable of oscillating the shock absorber along its longitudinal axis. Alternatively, mechanical motion may be imparted to the magnetic piston by application of a current to an active winding. The mechanical motion may be used to drive a compressor or a pump. Alternatively, a compressor or pump may be incorporated into the shock absorber. For example, the magnetic piston may sealingly engage the sides of the cylindrical wall and the two ends of the housing may have openings, to allow the movement of air or a fluid pumped by the movement of the piston.

An electromechanical shock absorber may be configured as a single stage having a single set of axial magnets, a single set of toroidal windings, and a single piston as described above. Alternatively, a device may have multiple stages, each with at least its own piston, which may operate in series, in parallel, or independently. When constructed with multiple stages, the individual stages may share components, such as outer or inner housings. Alternatively, multiple energy conversion devices may be connected electrically or mechanically in parallel or in series.

For active implementation, a control algorithm may be provided capable of analyzing the vibration characteristics of the surface and applying a current to the winding to provide piston deceleration and acceleration to tune the response of the shock absorber 50 to the terrain. The system may be designed to self-adjust to changing road conditions.

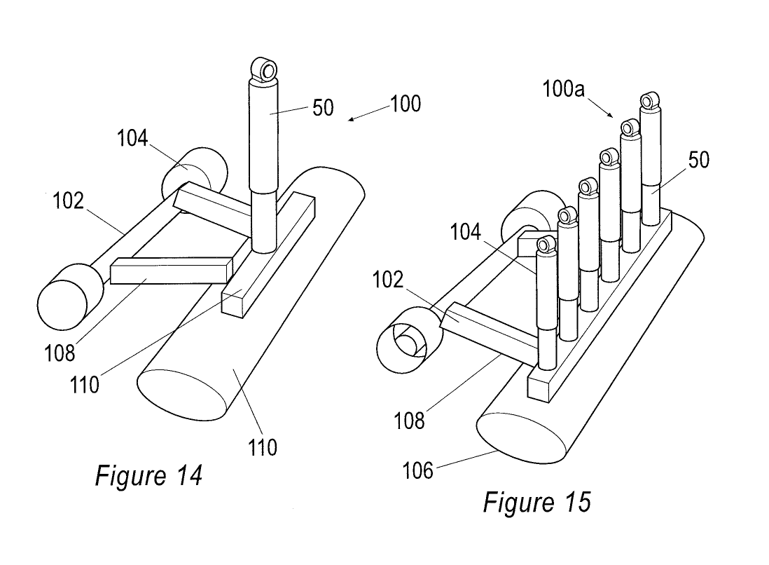

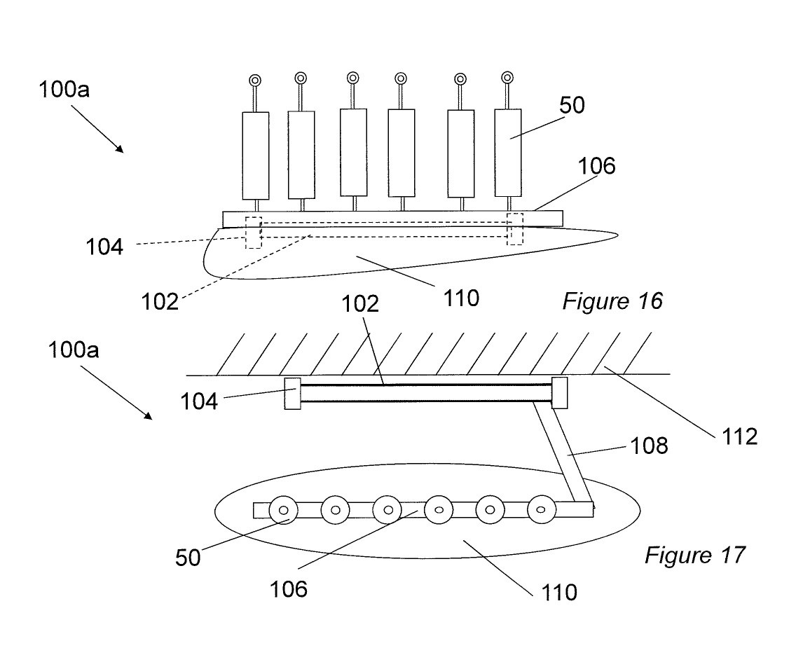

Referring now generally to FIGS. 14-19 various exemplary marine versions of a kinetic energy management system 100 similar one of the kinetic energy management systems described above are illustrated and the general arrangement of the mechanical, magnetic and electromagnetic components of kinetic energy management system 100 will be described.

Referring to FIG. 14, an exemplary kinetic energy management system 100 using a single electromagnetic shock absorber 50 is illustrated for attachment to a boat. Shock absorber 50 may be any of the exemplary shock absorbers described above. Kinetic energy management System 100 includes a frame structure including a shaft 102 having two or more wheels 104 for rolling engagement with the side of a boat, not shown in FIG. 14. A frame member 106 is secured parallel to shaft 102 by two or more cross members 108 extending between shaft 102 and frame member 106. Frame member 106 is attached to a top of a float, such as a pontoon 110. An electromagnetic shock absorber 50 is connected at one end to Frame member 106 and extends upwardly there from for interconnection with the side of a boat, not shown in FIG. 14.

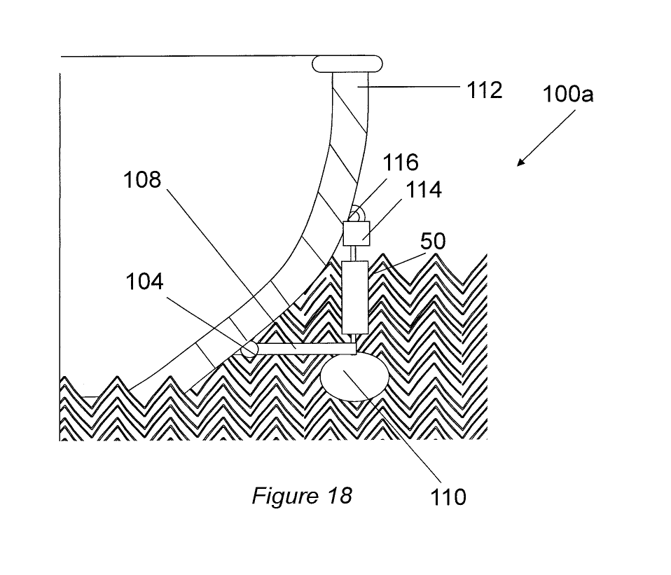

Referring to FIGS. 15-18, an exemplary kinetic energy management system 100a using a multiple electromagnetic shock absorbers 50 is illustrated for attachment to a boat 112 (see FIGS. 17 and 18). Kinetic energy management systems 100 may be attached to a boat 112 in a manner similar to that described for kinetic energy management systems 100a. The components of kinetic energy management system 100a include shaft 102, wheels 104, frame member 106, cross members 108 and pontoon 110, similar in form and function to those described above for kinetic energy management system 100, except that a plurality of electromagnetic shock absorbers 50 are each connected at one end to frame member 106 and extends upwardly there from for interconnection with the side of boat 112.

The upper end of each shock absorber 50 may be connected to the side of boat 110 by a spherical rod joint 116, as shown in FIG. 18, or an equivalent structure. Shaft 102 may be similarly attached to the side of boat 112 by a spherical rod joint or an equivalent structure. An elastomeric travel limiter or jounce stop 114 may be provided at the upper end of each shock absorber 50, as shown in FIG. 18, and designed to maintain torques within limits to avoid bending of components. Cross members 108 may be pivotally attached to frame member 106 so that shaft 102 and cross members 108 form a pivoting control arm for controlling the placement of pontoon 110 relative to side of boat 112. If desired, a third frame portion disposed at an angle above the pivoting control arm may be provided for additional securement to boat 112. Cross members 108 may be adjustable in length to accommodate differently shaped boats. Exemplary kinetic energy management system 100a may be installed so that shock absorbers 50 are generally perpendicular to the water, with the spherical rod joint assisting in fore-aft compliance.

Boat 112 may be provided with one or more kinetic energy management systems 100 or 100a on each side of the boat. It will be appreciated that the kinetic energy management systems 100 or 100a on each side of the boat may generate electricity from wave action whether boat 112 is in motion or is resting at anchor or at a dock. Kinetic energy management systems 100 and 100a also limit fore-aft motion of boat 112 (pitch) and side-to-side motion (roll) to provide stability to boat 112 due to the shape of pontoon 110. In particular, long properly designed pontoons function as outriggers while minimizing drag. One or more windings in shock absorbers 50 may be selectively powered to contract the shock absorbers and thereby raise the pontoon 110 from the water when desired.

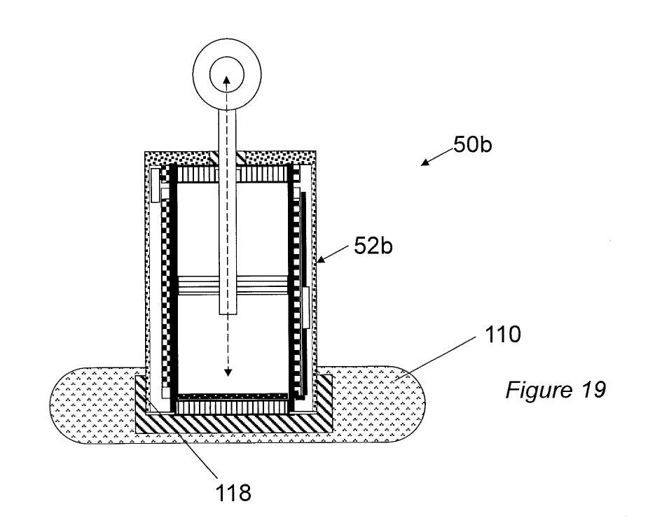

FIG. 19 illustrates yet another configuration for a kinetic energy management system wherein a cylinder 52b of a shock absorber 50b is fitted into a cavity 118 in a float 110 and affixed therein.

The above disclosure therefore provides a kinetic energy management system, the kinetic energy management system having a magnetic piston displaceable along a first longitudinal axis and a winding disposed about the first longitudinal axis to cyclically interact with the magnetic piston to induce an electrical current and voltage in the winding, thereby creating electrical energy. The system may have a plurality of said windings and plurality of magnetic pistons, each of said magnetic pistons cyclically imparting a magnetic field across one of said windings to contribute to the generation of electrical energy. The kinetic energy management system may have one of said magnet or said winding interconnected with a floatation component adapted for floating on the surface of a body of water and the other of and said magnet or winding interconnected with a boat whereby said kinetic energy management system may be used to manage the transverse vibration of the boat as it moves across the surface of the body of water. The flotation component may be a pontoon. Multiple shock absorbers may be mounted between the side of a boat and a pontoon. One or more kinetic management systems including a pontoon and a plurality of shock absorbers may be mounted on each side of a boat. The pontoons may be selectively raised from the water depending on conditions.

Features shown or described in association with one configuration may be added to or used alternatively in another configuration, including configurations described or illustrated in the provisional patent applications and the patent cooperation treaty patent application referred to in the above cross-reference to related applications. The scope of the device should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future configurations. In sum, it should be understood that the device is capable of modification and variation and is limited only by the following claims.

All terms are intended to be given their broadest reasonable constructions and their ordinary meanings as understood by those skilled in the art unless an explicit indication to the contrary in made herein. In particular, use of the singular articles such as “a” and “the,” should be read to recite one or more of the indicated elements unless a claim recites an explicit limitation to the contrary.

In one exemplary embodiment, a kinetic energy management system includes a shock absorber device comprising a first main body movably attached to a second main body for reciprocal movement there between, the first main body having a coil depending therefrom and the second main body having a magnet depending therefrom. The magnet may be movable relative to the coil by the reciprocal relative movement of the first and second main bodies such as to generate a current in the coil. One of the first or second main bodies is adapted for engaging with a vehicular component that experiences the irregularities of the surface on which the vehicle travels and the other of the main bodies is adapted for engaging a load-bearing portion of the vehicle for which isolation from the irregularities of the surface is desired. The interaction of the magnet and the coil may be used to translate between reciprocating kinetic energy associated with the motion of the vehicle over the surface irregularities and electrical energy associated with current through the coil.

What is claimed is:

1. A vehicular kinetic energy management system comprising:
a first main body having a passive magnetic component movable therewith;
a second main body movably attached to the first main body for reciprocal movement there between, the second main body having an active magnetic component movable therewith and positioned such as to magnetically communicate with the passive magnetic component;
one of the first and second main bodies being adapted for engagement with a vehicular component that experiences the irregularities of a surface on which the vehicle travels; and
the other of said first and second main bodies being adapted for engagement with a load bearing portion of the vehicle for which isolation from the vibrations due to irregularities of a surface on which the vehicle travels is desired, such that the interaction of the active and passive magnetic component in response to the relative movement of the first and second main bodies translates between reciprocating kinetic energy associated with the motion of the vehicle over the surface irregularities and electrical energy associated with the active magnetic component.

2. A vehicular kinetic energy management system according to claim 1 wherein the active magnetic component is a winding.

3. A vehicular kinetic energy management system according to claim 1 wherein the passive magnetic component is a permanent magnet.

4. A vehicular kinetic energy management system according to claim 1 further comprising two spaced apart fixed axial end magnets, the passive magnetic component being a magnetic piston having an axial magnetic field component, said magnetic piston being movably disposed between the two spaced apart fixed magnets and displaceable there between along a longitudinal axis.

5. A vehicular kinetic energy management system according to claim 4 further comprising a radial magnet disposed about the longitudinal axis, said magnetic piston further having a radial magnetic component.

6. A vehicular kinetic energy management system according to claim 4 further comprising a cylinder disposed about the longitudinal axis, said two spaced apart fixed axial end magnets being disposed adjacent opposing longitudinal ends of the cylinder and the passive magnetic component being movably disposed within the cylinder to reciprocate along the longitudinal axis between the two spaced apart fixed magnets.

7. A vehicular kinetic energy management system according to claim 4 wherein said active magnetic component comprises a winding disposed about the longitudinal axis.

8. A vehicular kinetic energy management system according to claim 1 further comprising a cylinder defining a longitudinal chamber, said active and passive magnetic components being disposed within the longitudinal chamber.

9. A vehicular kinetic energy management system according to claim 1 further comprising:
a housing;
a radial magnetic source affixed to the housing and
an axial magnetic source affixed to the housing;
said passive magnetic component being disposed in the housing and having an axial magnetic component responsive to the axial magnetic source and a radial magnetic component responsive to the radial magnetic source.

10. A vehicular kinetic energy management system according to claim 9 wherein said active magnetic component comprises a winding disposed within said housing.

11. A vehicular kinetic energy management system according to claim 1 further comprising a plurality of said first and second main bodies connected in a mechanical parallel arrangement.

12. A vehicular kinetic energy management system according to claim 1 further comprising a mechanical energy management system interposed between the first and second main bodies.

13. A vehicular kinetic energy management system according to claim 12 wherein said mechanical energy management system comprises at least one of a spring and a shock-absorbing device.

14. A vehicular kinetic energy management system according to claim 1 further comprising controls adapted to communicate with the active magnetic component.

15. A vehicular kinetic energy management system according to claim 1 wherein the vehicle is selected from a land motor vehicle and a boat.

16. A vehicular kinetic energy management system according to claim 1 further comprising a floatation system connected to one of the main bodies.

17. A vehicular kinetic energy management system comprising:
a generally cylindrical housing defining a longitudinal axis;
a first main body fixedly secured to the housing;
a second main body movably secured to the housing for reciprocal movement relative to the housing along said longitudinal axis;
a magnetic piston movably disposed within said housing and attacked to said second main body such as to be movable along the longitudinal axis;
a winding disposed within the housing about the longitudinal axis and communicating magnetically with the magnetic piston; and
a shock-absorbing component disposed between the first and second main bodies.

18. A vehicular kinetic energy management system according to claim 17 further comprising two spaced apart fixed axial end magnets disposed within the housing adjacent opposite ends of the longitudinal axis, the magnetic piston having an axial magnetic field component, said magnetic piston being movably disposed between the two spaced apart fixed magnets and displaceable there between along the longitudinal axis.

19. A vehicular kinetic energy management system according to claim 17 further comprising a radial magnet disposed about the longitudinal axis, said magnetic piston further having a radial magnetic component.

20. A vehicular kinetic energy management system according to claim 19 wherein said mechanical energy management system is selected from a spring and a shock-absorbing device.

21. A vehicular kinetic energy management system comprising:
a first main body;
a second main body movably secured to the first main body for reciprocal movement relative thereto along a longitudinal axis;
a magnetic piston attacked to said second main body such as to be movable along the longitudinal axis;
an active magnetic component disposed about the longitudinal axis and communicating magnetically with the magnetic piston; and
a flotation component attached to one of the first and second main bodies, the other of the first and second main bodies that is not attached to the flotation component being adapted for engagement with a boat.

22. A vehicular kinetic energy management system according to claim 21 further comprising an anchoring system mechanically disposed between the flotation component and the boat to maintain the longitudinal axis of the vehicular kinetic energy management system in a generally vertical direction.

23. A vehicular kinetic energy management system according to claim 22 wherein the anchoring system further comprises:
a frame member extending generally horizontally from the flotation component; and
an engagement surface at the end of the frame member adapted for moving engagement with the boat.

24. A vehicular kinetic energy management system according to claim 23 wherein the engagement surface comprises at least one wheel rotatably depending from the frame member.
